(19) United States
(12) Patent Application Publication
(10) Pub. No.: US 2026/0182559 A1
(43) Pub. Date: Jul. 2, 2026

(54) INTEGRATED SYSTEMS FOR WEED REMOVAL AND RED IMPORTED FIRE ANT CONTROL IN PHOTOVOLTAIC POWER PLANTS

(71) Applicant: GUANGDONG OCEAN UNIVERSITY, Zhanjiang (CN)

(72) Inventors: Qing XU, Zhanjiang (CN); Shengxian XIAN, Zhanjiang (CN); Jiayi SHAO, Zhanjiang (CN); Ye XIE, Zhanjiang (CN); Zhisi YANG, Zhanjiang (CN); Zijie YIN, Zhanjiang (CN); Dongxue YAO, Zhanjiang (CN); Jiahao GAN, Zhanjiang (CN)

(73) Assignee: GUANGDONG OCEAN UNIVERSITY, Zhanjiang (CN)

(21) Appl. No.: 19/533,281

(22) Filed: Feb. 8, 2026

Related U.S. Application Data
(63) Continuation of application No. PCT/CN2025/140206, filed on Dec. 5, 2025.

(30) Foreign Application Priority Data
Dec. 30, 2024 (CN) 202411971172.3

(51) Int. Cl. A01M 7/00; A01M 1/10; A01M 21/02; F28C 1/00; G01B 11/06; G01G 11/00

(52) U.S. Cl. CPC A01M 7/0042; A01M 1/103; A01M 21/02; F28C 1/00; G01B 11/0608; G01G 11/00

(57) ABSTRACT

Disclosed is an integrated system for weed removal and red imported fire ant control in a photovoltaic power plant. The integrated system includes: a filament cutting device installed below a photovoltaic panel to cut weeds, equipped with a laser sensor for real-time weed growth detection and a pesticide spraying assembly; a conveying device, connected at one end to a collection trough at a bottom of the filament cutting device and arranged in an inclined manner, featuring a power recovery assembly; a trapping device installed at the other end of the conveying device at a lower elevation than the collection trough, equipped with a spraying assembly; and a heat dissipation device having an evaporation end disposed on a backsheet of the photovoltaic panel and a condensation end at a position corresponding to the trapping device. The power recovery assembly is configured to drive refrigerant flow within the heat dissipation device.

### CROSS-REFERENCE TO RELATED APPLICATIONS

This application is a Continuation of International Application No. PCT/CN2025/140206, filed on Dec. 5, 2025, which claims priority to Chinese Patent Application No. 202411971172.3, filed on Dec. 30, 2024, the entire contents of each of which are hereby incorporated by reference.

### TECHNICAL FIELD

The present disclosure relates to a field of photovoltaic power plant technology, and in particular to an integrated system for weed removal and red imported fire ant control in a photovoltaic power plant.

### BACKGROUND

Photovoltaic (PV) power generation stands as one of the most promising renewable energy power generation technologies. A PV power plant primarily consists of PV panels, a controller, and an inverter. The PV panels convert solar radiation into electricity through a photovoltaic effect and serve as the core component of the PV power plant. However, during actual operation, when PV panels are installed on sloped terrain, the ground behind the panels is often overgrown with weeds. Excessive weed growth not only leads to erosion of backsheets of the PV panels but also shades the panels from sunlight, reducing their power generation efficiency. Therefore, how to manage weeds in PV power plants is a current problem awaiting a solution. Furthermore, the transmission lines of PV power plants operate in high-temperature environments, which easily attracts gnawing by red imported fire ants (Solenopsis invicta). This may result in damage to the wire insulation and even short circuits, seriously compromising the stability and safety of the PV power plant.

Consequently, there is an urgent need to provide an integrated system for weed removal and red imported fire ant control in a PV power plant, to simultaneously suppress weed growth and prevent damage to wires by the fire ants, thereby enhancing the power generation efficiency and operational stability of the PV power plant.

### SUMMARY

One or more embodiments of the present disclosure provide an integrated system for weed removal and red imported fire ant control in a photovoltaic power plant. The integrated system includes a filament cutting device, a conveying device, a trapping device, and a heat dissipation device. The filament cutting device is installed below a photovoltaic panel and configured to cut weeds below the photovoltaic panel. A laser sensor for detecting a weed growth status in real time is installed on the filament cutting device, and a pesticide spraying assembly is arranged on the filament cutting device. A collection trough is arranged at a bottom of the filament cutting device, and an end of the conveying device is connected to the collection trough. The conveying device is arranged in an inclined manner, and a power recovery assembly is arranged on the conveying device. The trapping device is installed at another end of the conveying device. An elevation of the trapping device is lower than an elevation of the collection trough. A spraying assembly is installed on the trapping device. An evaporation end of the heat dissipation device is arranged on a backsheet of the photovoltaic panel, a condensation end of the heat dissipation device is arranged at a position corresponding to the trapping device, and the power recovery assembly is configured to drive a refrigerant in the heat dissipation device to flow.

The present disclosure provides the following advantages and beneficial effects:

The integrated system for weed removal and red imported fire ant control in a photovoltaic power plant, as provided by the embodiments of the present disclosure, utilizes a filament cutting device to clear weeds from the ground beneath the photovoltaic panels. This achieves automated weed clearance in the power plant, prevents erosion and damage to the panels caused by weeds, and reduces the labor cost associated with manual weed removal. When the filament cutting device is stopped, the elongate filament is not capable of cutting, thereby posing no risk of injury to pedestrians and improving the safety of the system. The filament cutting device is equipped with a laser sensor, facilitating the cutting and subsequent transport of weeds to a designated location when the weeds grow to a certain height or when there is a need to utilize them.

The system uses the gravitational force of the cut weeds themselves to transport them to a trapping device. The energy generated during this process is recovered by a power recovery assembly, which in turn drives a pressure roller to operate. The pressure roller compresses a flexible hose, causing the refrigerant within to circulate. The refrigerant releases heat at the condenser to heat and dry the pile of weeds. Subsequently, the refrigerant flows to the evaporator, where it absorbs heat from the backsheets of the photovoltaic panels, thereby cooling the backsheets. This enhances the efficiency of the panels and reduces potential damage. The conveying device transports the cut weeds to a designated area. Under solar radiation, this area can reach high temperatures; alternatively, high temperatures may develop from the slow oxidative heating of the piled weeds, or from the heat transferred from the backsheets of the panels to the weed pile. This environment aligns with the preferences of red imported fire ants, causing them to congregate in the weed pile, where further control measures can be applied. Consequently, the problem of preventing fire ants from gnawing on electrical wires is addressed without the need for external material input, reducing the cost of fire ant control in the photovoltaic power plant and improving economic efficiency.

Utilizing the weeds cut by the filament cutting device for fire ant control, rather than relying on chemical additives, is beneficial for improving environmental outcomes and adhering to the principle of environmental protection. Furthermore, this approach represents a secondary use of the cut weeds, reducing the secondary costs associated with weed disposal and enhancing the economic benefits of the photovoltaic power plant.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is an exemplary block diagram of an integrated system for weed removal and red imported fire ant control in a photovoltaic power plant according to some embodiments of the present disclosure;

FIG. 2 is an exemplary schematic structural diagram of the integrated system for weed removal and red imported fire ant control in a photovoltaic power plant according to some embodiments of the present disclosure; and

FIG. 3 is an exemplary schematic connection diagram illustrating a power recovery assembly, a conveying device, and a heat dissipation device according to some embodiments of the present disclosure;

Reference numerals in the drawings: 1, weed; 2, motor; 3, elongate filament; 4, condenser; 5, weed pile; 6, drawstring mesh retaining cover; 7, laser sensor; 8, conveyor belt; 9, one-way baffle; 10, weight sensor; 11, pesticide nozzle; 12, stepper motor; 13, pressure roller; 14, flexible hose; 15, evaporator; 16, semi-cylindrical cover; 17, guardrail; 18, spraying nozzle; 19, fixing frame.

### DETAILED DESCRIPTION

To more clearly illustrate the technical solutions in the embodiments of the present disclosure, the drawings used in the description of the embodiments will be briefly introduced below. Obviously, the drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

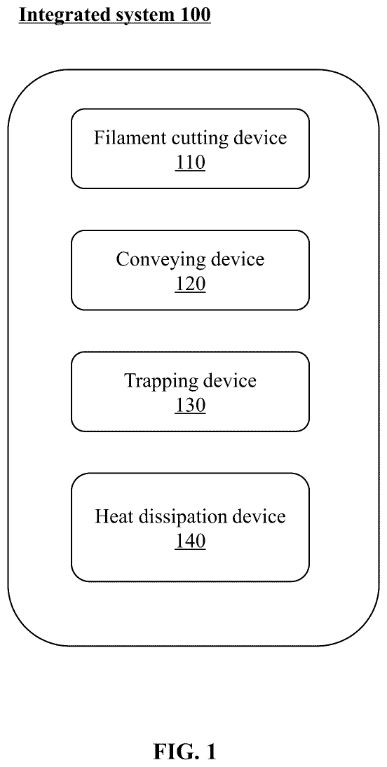

FIG. 1 is an exemplary block diagram of an integrated system for weed removal and red imported fire ant control in a photovoltaic power plant according to some embodiments of the present disclosure.

In some embodiments, as shown in FIG. 1, an integrated system 100 for weed removal and red imported fire ant control in a photovoltaic power plant includes a filament cutting device 110, a conveying device 120, a trapping device 130, and a heat dissipation device 140.

The filament cutting device refers to a mechanical device used for cutting weeds below photovoltaic panels. For example, the filament cutting device may include a rotary cutting filament, an electric lawn mower blade, or the like.

In some embodiments, the filament cutting device may be installed below the photovoltaic panels.

In some embodiments, the filament cutting device is configured to cut weeds below the photovoltaic panels.

In some embodiments, a laser sensor for detecting a weed growth status in real-time is installed on the filament cutting device, and a pesticide spraying assembly is arranged on the filament cutting device.

The laser sensor refers to an electronic device that utilizes a laser beam for detection, measurement, or identification. For example, the laser sensor may include a laser distance measuring sensor, a laser profile scanner, or the like.

In some embodiments, the laser sensor may detect a height of the weeds below the photovoltaic panels and send a trigger signal to the filament cutting device.

The pesticide spraying assembly refers to an automated device for precisely spraying herbicide, fertilizer, or other liquid agents. For example, the pesticide spraying assembly may include a high-pressure atomizing nozzle, a precision variable-rate spraying system, or the like.

In some embodiments, the pesticide spraying assembly may comprise a nozzle, a pump, a liquid storage tank, a control system, or the like.

In some embodiments, in response to a weed signal from the laser sensor, the pesticide spraying assembly may spray herbicide onto the weeds below the photovoltaic panels.

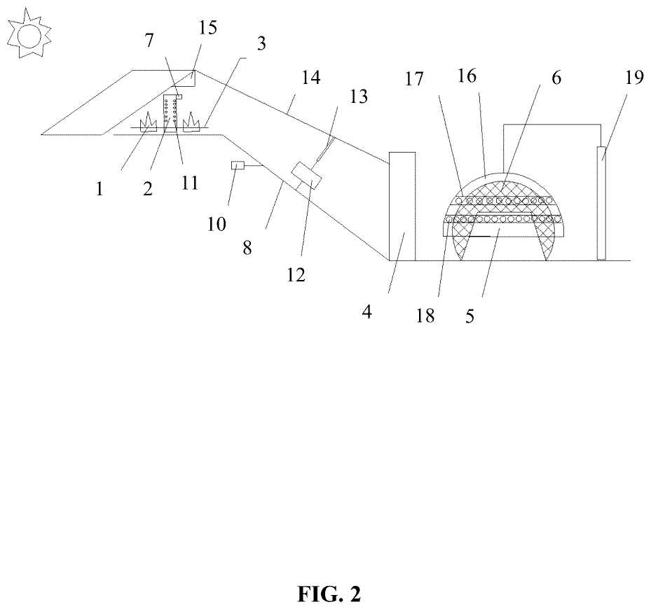

FIG. 2 is an exemplary schematic structural diagram of the integrated system for weed removal and red imported fire ant control in a photovoltaic power plant according to some embodiments of the present disclosure.

In some embodiments, as shown in FIG. 2, to facilitate the cutting of weeds 1, the filament cutting device includes a motor 2. An elongate filament 3 is connected to an output shaft of the motor 2. The laser sensor 7 is installed on a top of the motor 2. A plurality of pesticide nozzles 11 are arranged on a housing of the motor 2, and the plurality of pesticide nozzles 11 are arranged circumferentially around the motor 2.

The motor refers to a device that converts electrical energy into mechanical energy. For example, the motor may include a DC brushed motor, a brushless motor, a stepper motor, or the like.

In some embodiments, the motor may be used to drive the elongate filament of the filament cutting device to rotate or reciprocate, thereby achieving a weed removal function.

The output shaft refers to a rotating shaft of the motor. For example, the output shaft may include a solid shaft, a hollow shaft, or the like.

In some embodiments, the output shaft may be used to transmit power, and to connect and drive the elongate filament to perform a cutting motion.

The elongate filament refers to a flexible cutting tool. For example, the elongate filament may include a nylon-coated steel wire, a diamond-coated cutting filament, a carbon fiber cord, or the like.

In some embodiments, the elongate filament may be made of a high-strength material and cut weeds through high-speed rotation or oscillation.

The housing refers to an outer shell structure of the motor. For example, the housing may include an aluminum alloy casing, an engineering plastic casing, or the like.

In some embodiments, the housing may be used to protect internal components and provide mounting interfaces (e.g., for the laser sensor and the pesticide nozzles).

The pesticide nozzle refers to an opening provided on the housing of the motor. For example, the pesticide nozzle may include a fan-pattern nozzle, a micro-atomizing nozzle, an anti-drip nozzle, or the like.

In some embodiments, the pesticide nozzle may be used to spray herbicide or the like, to assist in weed removal or inhibit weed regrowth.

The term “arranged circumferentially” means that the pesticide nozzles are evenly distributed along a circumferential direction of the housing of the motor. For example, four pesticide nozzles may be arranged on the housing of the motor with an angular spacing of 90° between adjacent nozzles, suitable for a square weeding area. As another example, six pesticide nozzles may be arranged on the housing of the motor with an angular spacing of 60° between adjacent nozzles, suitable for a circular area or a high-density weed area.

In some embodiments of the present disclosure, by integrating the laser sensor, the filament cutting device, and the pesticide nozzles onto the housing of the motor, a highly compact weeding module is formed, which significantly improves the efficiency and precision of weeding operations. The laser sensor detects weed locations in real time and controls the filament cutting device to perform precise cutting. Simultaneously, the circumferentially arranged pesticide nozzles enable immediate, targeted spraying of a target area after cutting, effectively reducing herbicide usage and minimizing environmental pollution. The design of uniformly distributing the pesticide nozzles circumferentially ensures a 360-degree, dead-angle-free coverage of a cutting zone with a liquid agent, making it particularly suitable for weed management in confined spaces such as an area below the photovoltaic panels.

The conveying device refers to a mechanical device for collecting and transporting cut weeds. For example, the conveying device may include an inclined belt conveyor, a screw conveyor, a vibratory feed chute, or the like.

In some embodiments, a collection trough is arranged at a bottom of the filament cutting device, and an end of the conveying device is connected to the collection trough. The conveying device is arranged in an inclined manner, and a power recovery assembly is provided on the conveying device.

In some embodiments, the trapping device is installed at another end of the conveying device, and an elevation of the trapping device is lower than an elevation of the collection trough. For example, a high end of the conveying device is connected to the collection trough, and a low end of the conveying device is connected to the trapping device.

Elevation refers to a vertical height of a point relative to a reference plane (e.g., the ground, a horizontal plane).

In some embodiments, setting the elevation of the trapping device lower than the elevation of the collection trough allows the weeds to slide from the collection trough to the trapping device along the inclined conveying device under gravitational force. The kinetic energy from this motion is converted via the power recovery assembly into a mechanical driving force for a pressure roller.

Further description regarding the trapping device and the pressure roller may be found in the relevant sections below.

The collection trough refers to a trough-shaped structure for receiving waste material (e.g., weeds) generated during the filament cutting process. For example, the collection trough may include a stainless steel double-layer filtering collection trough, a corrosion-resistant polypropylene graded collection trough, or the like.

The term “arranged in an inclined manner” means that the conveying device is installed at a certain angle of inclination.

In some embodiments, arranging the conveying device in an inclined manner allows weeds to slide naturally toward the collection trough.

The power recovery assembly refers to a device that recovers residual energy (e.g., kinetic energy) generated during the operation of the integrated system and converts it into usable energy. For example, the power recovery assembly may include a flywheel energy storage device, an electromagnetic induction-based electrical energy recovery unit, a spring-based mechanical energy recovery unit, or the like.

In some embodiments, the power recovery assembly may recover kinetic energy generated during deceleration of the conveying device and store the kinetic energy in a battery.

In some embodiments, as shown in FIG. 2, the conveying device includes a conveyor belt 8 in communication with the collection trough. The conveyor belt 8 is arranged in an inclined manner, and a weight sensor 10 is installed on the conveyor belt 8. The power recovery assembly is operatively coupled to the conveyor belt 8.

The conveyor belt refers to an endless loop belt made of a flexible material. In some embodiments, the flexible material may include rubber, PVC, a metal mesh belt, or the like.

The weight sensor refers to an electronic device for detecting the weight of an object. For example, the weight sensor may include a strain gauge sensor, a piezoelectric sensor, a capacitive sensor, or the like.

In some embodiments, the weight sensor may convert a mechanical signal into an electrical signal output based on the strain gauge principle, piezoelectric effect, or capacitive principle.

In some embodiments, the weight sensor may monitor a load of weeds on the conveyor belt in real time to regulate a conveying speed or trigger an alarm prompting cleaning. For example, the weight sensor monitors the load of weeds on the conveyor belt in real time and dynamically adjusts the conveying speed or triggers an alarm prompting cleaning according to a preset threshold range. Merely by way of example, when the load is below a lower limit of the preset threshold range, the integrated system automatically reduces the conveying speed to save energy; when the load is within the preset threshold range, the conveying speed is maintained at a stable operating state; if the load exceeds an upper limit of the preset threshold range, the integrated system immediately triggers an alarm prompting cleaning and may simultaneously halt the conveying device to avoid overload damage.

The The term “operatively coupled” means that the power recovery assembly and the conveyor belt are connected via a mechanical connection means or an electromagnetic coupling means to achieve power transmission and collaboration. The mechanical connection means may include a gear, chain, belt, or the like. The electromagnetic coupling means may include an electromagnetic clutch, an induction motor, or the like.

In some embodiments, the power recovery assembly may convert kinetic energy of the conveyor belt into storable or reusable energy (e.g., electrical energy, mechanical energy). For example, when the conveyor belt decelerates due to a change in load or a stop operation, the inertial kinetic energy of the conveyor belt drives the power recovery assembly via a transmission mechanism, converting the kinetic energy into reusable stored energy. When the conveyor belt starts up or requires additional power, the energy stored in the power recovery assembly is released in reverse through the transmission mechanism to assist in driving the operation of the conveyor belt.

The transmission mechanism refers to an energy transfer path between the power recovery assembly and the conveyor belt. For example, the transmission mechanism includes a mechanical connection assembly, an electromagnetic coupling assembly, or the like.

In some embodiments of the present disclosure, by operatively coupling the power recovery assembly to the conveyor belt, the recovery and reuse of kinetic energy during braking of the conveyor belt is achieved, significantly improving the energy utilization efficiency of the integrated system. Simultaneously, the weight sensor installed on the conveyor belt can monitor load changes in real time and work collaboratively with the power recovery assembly to dynamically adjust an intensity of energy recovery based on a magnitude of the load, further optimizing energy management efficiency.

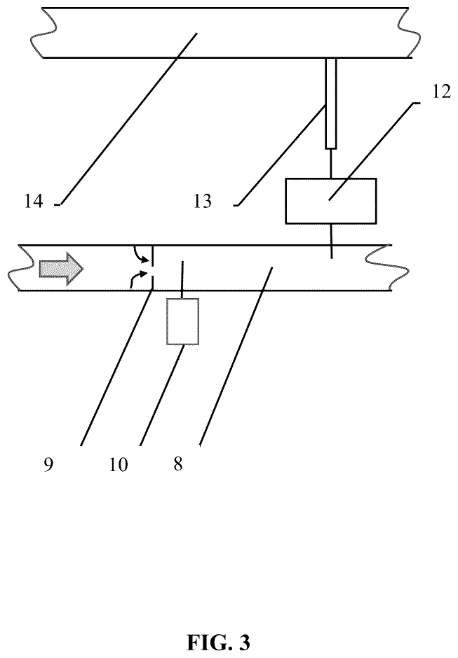

FIG. 3 is an exemplary schematic connection diagram illustrating a power recovery assembly, a conveying device, and a heat dissipation device according to some embodiments of the present disclosure.

In some embodiments, as shown in FIG. 3, to prevent reverse conveyance of the weeds 1, a one-way baffle 9 is installed on the conveyor belt 8.

The one-way baffle refers to a device that, through specific structural design (e.g., a baffle, a protrusion, an inclined surface, etc.), restricts weeds to pass in only one direction. For example, the one-way baffle on the conveyor belt may allow weeds to pass by being depressed when sliding in a forward direction and, upon reverse conveyance, reset to an upright position to form a barrier, thereby preventing rollback.

In some embodiments, the one-way baffle may include a fixed baffle, a flexible rubber baffle, an inclined guide baffle, or the like.

In some embodiments, the one-way baffle can ensure that weeds move in only one direction during conveyance, preventing reverse sliding or scattering of weeds caused by inertia, gravity, or external disturbances (e.g., vibration, inclination).

In some embodiments of the present disclosure, by installing the one-way baffle on the conveyor belt, the stability and efficiency of weed conveyance are effectively enhanced. The one-way baffle can prevent weeds from rolling back or slipping during conveyance due to inertia or slope, making it particularly suitable for scenarios involving inclined conveyance or transport of loose weeds. Furthermore, the structural design of the one-way baffle can reduce relative sliding between the weeds and the conveyor belt, lower friction loss, and extend the service life of the conveyor belt.

In some embodiments, as shown in FIG. 2, the power recovery assembly includes a stepper motor 12. A pressure roller 13 is connected to an output shaft of the stepper motor 12. An end of the pressure roller 13 is operatively coupled to a peristaltic pump in the heat dissipation device.

The stepper motor refers to an electric motor that converts electrical pulse signals into precise angular or linear displacement. For example, the stepper motor may include a two-phase hybrid stepper motor, a five-phase stepper motor, a closed-loop stepper motor, or the like.

The output shaft refers to a mechanical component of the stepper motor for transmitting power and torque. For example, the output shaft may include a solid shaft, a keyed shaft, a hollow shaft, or the like.

In some embodiments, the output shaft may be a metallic shaft body, with one end connected to a rotor of the stepper motor and the other end driving the pressure roller.

In some embodiments, the output shaft may be connected to the pressure roller via a rigid coupling or a keyed connection to ensure transmission efficiency.

In some embodiments, the output shaft may transmit rotational motion of the stepper motor to the pressure roller.

The pressure roller refers to a cylindrical component that applies pressure or transmits power through rolling contact. For example, the pressure roller may include a rubber-coated roller, a smooth steel roller, a grooved roller, or the like.

In some embodiments, the pressure roller may be made of metal, rubber, or a composite material, and its surface may be textured to enhance friction.

Further description regarding the heat dissipation device and the peristaltic pump may be found in the relevant sections below.

In some embodiments, the stepper motor may precisely control the rotation of the pressure roller, ensuring stable operative coupling with the peristaltic pump.

In some embodiments of the present disclosure, by combining the stepper motor with the pressure roller and the peristaltic pump, an efficient power recovery assembly is formed. The stepper motor drives the output shaft to rotate the pressure roller. The operative coupling between the end of the pressure roller and the peristaltic pump achieves the conversion of mechanical energy into hydraulic energy. This effectively recovers mechanical power that would otherwise be wasted and utilizes it for the heat dissipation system. Not only does this improve energy utilization efficiency, but it also simplifies the structure of the integrated system and reduces energy consumption.

The trapping device refers to a device for trapping and exterminating red imported fire ants. For example, the trapping device may include a bait station (containing insecticide specific to red imported fire ants), an adhesive trap, an electric shock-based ant exterminator, or the like.

In some embodiments, a spraying assembly is installed on the trapping device.

The spraying assembly refers to a system comprising a liquid supply device (e.g., a water pump, a water tank) and nozzles. For example, the spraying assembly may include a high-pressure atomizing spray head, a fan-shaped spraying nozzle, an electromagnetic valve-controlled spray, or the like.

In some embodiments, the spraying assembly may be used to spray a liquid (e.g., water, an agent) to achieve functions such as cleaning or extermination. For example, the spraying assembly sprays an agent to exterminate red imported fire ants. As another example, the spraying assembly periodically sprays water for rinsing to prevent clogging or corrosion of the trapping device.

In some embodiments, as shown in FIG. 2, the trapping device includes a weed pile 5. To facilitate bundling of the weed pile 5, a drawstring mesh retaining cover 6 is sleeved over an outer side of the weed pile.

The weed pile refers to an accumulation of weeds formed by cutting, collecting, and conveying them into the trapping device. In some embodiments, the weed pile may serve as bait or a habitat environment for red imported fire ants to attract and trap them.

The drawstring mesh retaining cover refers to a mesh cover with adjustable tightness. For example, the drawstring mesh retaining cover may include an agricultural cover net, a garden containment net, a reusable cover, or the like.

In some embodiments, the drawstring mesh retaining cover may be tightened or loosened by pulling a drawstring, and is arranged around the outer side of the weed pile to secure the weeds and prevent scattering.

In some embodiments of the present disclosure, by providing the drawstring mesh retaining cover, the tightness of the cover around the weed pile can be flexibly adjusted, ensuring that the weeds are effectively secured and less prone to scattering, while also facilitating quick gathering and removal during subsequent cleanup. The mesh structure not only blocks weed overflow but also allows air circulation, preventing excessive internal humidity that may lead to rotting.

In some embodiments, as shown in FIG. 2, to reduce the likelihood of red imported fire ants escaping, a coating layer for preventing gnawing by red imported fire ants is provided on the drawstring mesh retaining cover 6.

The coating refers to a protective layer applied to a surface of the drawstring mesh retaining cover. For example, the coating may include a silicone resin coating, a polyurethane coating, a fluoropolymer coating, or the like.

In some embodiments, the coating layer may comprise delphinium essential oil.

In some embodiments of the present disclosure, by providing the coating layer for preventing gnawing by red imported fire ants on the surface of the drawstring mesh retaining cover, damage to the drawstring mesh retaining cover by pests such as red imported fire ants can be effectively prevented. This ensures the long-term stable use of the drawstring mesh retaining cover, avoiding weed scattering or trapping failure caused by gnawing. The coating layer not only enhances the durability of the drawstring mesh retaining cover but also reduces costs associated with frequent replacement or maintenance, while maintaining the trapping functionality of the weed pile, thereby improving the practicality and economic efficiency of the integrated system.

In some embodiments, as shown in FIG. 2, the spraying assembly includes a fixing frame 19. A semi-cylindrical cover 16 is installed on the fixing frame 19 and arranged above the weed pile 5. A guardrail 17 is installed on an outer wall of the semi-cylindrical cover 16. The guardrail 17 is arranged along a circumferential direction of the semi-cylindrical cover 16. A plurality of spraying nozzles 18 are arranged on the guardrail 17. The spraying nozzles 18 are configured to spray water vapor. The plurality of spraying nozzles 18 are arranged at equal intervals along a circumferential direction of the guardrail 17.

The fixing frame refers to a support structure of the spraying assembly. In some embodiments, the fixing frame may be constructed by welding metal (e.g., stainless steel or galvanized steel).

In some embodiments, the fixing frame may be used to mount and secure components such as the semi-cylindrical cover and the guardrail, ensuring the stability and positional accuracy of the spraying assembly.

The semi-cylindrical cover refers to a curved covering structure mounted on the fixing frame. In some embodiments, the semi-cylindrical cover may be made of heat-resistant plastic or a lightweight metal (e.g., aluminum alloy).

In some embodiments, the semi-cylindrical cover may be used to concentrate the spraying range and reduce water vapor dispersion, thereby improving thermal energy utilization efficiency.

The guardrail refers to a protective and spray-carrying structure installed circumferentially along the outer wall of the semi-cylindrical cover.

In some embodiments, the guardrail may be made of hollow steel pipe, with a steam conduit passing through its interior.

In some embodiments, the guardrail is uniformly distributed or installed along the circumferential direction of the outer wall of the semi-cylindrical cover, forming a surrounding structure. For example, the guardrail extends along an arcuate path on an outer surface (or edge) of the semi-cylindrical cover, centered on a central axis of the semi-cylindrical cover, covering the entire perimeter of the semi-circle (a 180°range).

The spraying nozzle refers to an orifice or a nozzle provided on the guardrail. For example, the spraying nozzle may include a fan-pattern nozzle, an atomizing nozzle, a direct steam jet nozzle, or the like.

In some embodiments, the spraying nozzle may be used to directionally spray water vapor onto the weed pile, maintaining a suitable humidity level inside the weed pile to attract and aggregate red imported fire ants.

In some embodiments, the plurality of spraying nozzles are uniformly distributed along the circumferential direction of the guardrail at equal intervals, ensuring uniformity and efficiency of spray coverage. For example, the spraying nozzles are arranged along the arcuate path of the guardrail (i.e., the circumferential direction of the semi-cylindrical cover), with equal arc length or linear distance between each spraying nozzle. Merely by way of example, if six spraying nozzles are installed on the semi-circular perimeter (180° range) of the guardrail, the angular spacing between adjacent spraying nozzles is 30°.

In some embodiments, the semi-cylindrical cover is arranged above the weed pile, forming a partially enclosed space that prevents rapid dispersion of water vapor. Simultaneously, the annular structure of the guardrail provides stable support for the spraying nozzles, ensuring even distribution of the water vapor. The spraying nozzles are equally spaced along the circumferential direction of the guardrail, enabling the water vapor to cover the entire surface of the weed pile in an atomized form. This not only maintains the humidity of the weed pile to attract red imported fire ants but also utilizes waste heat from the condenser to heat the warm water vapor (generated by the water heating device of the heat dissipation device), thereby raising the temperature of the weed pile and simulating the humid, warm environment preferred by red imported fire ants. Furthermore, the corrosion-resistant design of the guardrail and the flow-guiding effect of the semi-cylindrical cover collectively ensure the long-term durability and high efficiency of the spraying system. Additionally, the spraying nozzles are in communication with a water vapor outlet of the heat dissipation device, forming a closed-loop thermal energy utilization system that further enhances trapping effectiveness.

In some embodiments of the present disclosure, through the optimized design of the spraying assembly, the efficiency and safety of weed treatment are significantly improved. The combined structure of the fixing frame and the semi-cylindrical cover can precisely cover the weed pile, ensuring uniform distribution of water vapor and avoiding issues such as localized overheating or incomplete treatment. The guardrail not only enhances the overall structural stability but also, through the circumferentially equally-spaced spraying nozzles, achieves omnidirectional, dead-angle-free spraying, effectively improving weed decomposition efficiency. Meanwhile, the use of water vapor avoids environmental pollution caused by chemical agents, aligns with green environmental requirements, and ensures safe and reliable operation.

The heat dissipation device refers to a device that utilizes waste heat from photovoltaic panels for heat exchange. For example, the heat dissipation device may include a heat pipe cooling system, a phase change material cooling device, a thermoelectric cooling module, or the like.

In some embodiments, an evaporation end of the heat dissipation device is disposed on a backsheet of the photovoltaic panel, and a condensation end of the heat dissipation device is arranged at a position corresponding to the trapping device. The power recovery assembly is configured to drive a refrigerant in the heat dissipation device to flow.

Further description regarding the power recovery assembly may be found in the relevant sections above.

The evaporation end refers to a portion of the heat dissipation device that absorbs heat and causes the refrigerant to evaporate from a liquid state to a gaseous state.

In some embodiments, the evaporation end may include a heat-absorbing substrate, an evaporation section of a heat pipe, a microchannel evaporator, or the like.

The heat-absorbing substrate refers to a metal plate (e.g., copper, aluminum) or a graphene thermal conductive layer that is directly attached to the backsheet of the photovoltaic panel. In some embodiments, the heat-absorbing substrate may be welded to a heat pipe.

In some embodiments, the evaporation end, via the heat-absorbing substrate, may absorb waste heat from the photovoltaic panel, causing the refrigerant to vaporize upon heating, thereby carrying away heat and reducing a temperature of the photovoltaic panel.

The condensation end refers to a portion of the heat dissipation device that releases heat and causes the refrigerant to condense from the gaseous state to the liquid state.

In some embodiments, the condensation end may include a heat sink, a condenser tube, or the like.

In some embodiments, a heated air outlet of the condensation end is aligned with an inlet of the trapping device, and the heat sink of the condensation end is embedded in a housing of the trapping device.

The refrigerant refers to a medium that circulates within the heat dissipation device and transfers heat through phase change. For example, the refrigerant may include ammonia, Freon, water, or the like.

In some embodiments, the refrigerant absorbs heat and vaporizes at the evaporation end, is propelled to the condensation end by the power recovery assembly to release heat and liquefy, thereby forming a cycle.

In some embodiments, as shown in FIG. 2, the heat dissipation device includes an evaporator 15 and a condenser 4. The evaporator 15 is installed on the backsheet of the photovoltaic panel. A water heating device is arranged at a position corresponding to the condenser 4. A water vapor outlet of the water heating device is in communication with the spraying nozzles 18. A closed loop is formed between the evaporator 15 and the condenser 4 via a flexible hose 14. A peristaltic pump is arranged on the flexible hose 14, and the power recovery assembly is operatively coupled to the peristaltic pump. An outlet end of the condenser 4 is in fluid communication with a refrigerant heat recovery heat exchanger, and an outlet end of the refrigerant heat recovery heat exchanger is in fluid communication with the evaporator 15.

The evaporator refers to a heat-absorbing component within the heat dissipation device. For example, the evaporator may include an aluminum finned evaporator or the like.

In some embodiments, the evaporator may be made of a high thermal conductivity material (e.g., aluminum or copper) and internally designed with multi-channel or microchannel structures to increase a heat exchange area, while allowing the refrigerant to flow internally. In some embodiments, the evaporator may absorb external heat through evaporation of the refrigerant, thereby achieving cooling or heat energy recovery.

The condenser refers to a heat-releasing component within the heat dissipation device. For example, the condenser may include a copper tube-aluminum fin condenser or the like.

In some embodiments, the condenser may transfer heat to the water heating device.

The water heating device refers to a device that utilizes heat released from the condenser to heat water, causing it to evaporate or increase in temperature. For example, the water heating device may include a helical coil, a plate heat exchanger, or the like.

The water vapor outlet refers to an exhaust port for water vapor in the water heating device. For example, the water vapor outlet may include an adjustable-angle nozzle, a diffuser tube, or the like.

In some embodiments, the water vapor outlet may be made of stainless steel, ceramic, or the like. In some embodiments, the water vapor outlet may be used to directionally release water vapor.

In some embodiments, the water heating device receives heat from the condenser, heats the water to generate water vapor, and delivers the water vapor to the spraying nozzles via the water vapor outlet.

The flexible hose is a flexible conduit for connecting components such as the evaporator and the condenser. For example, the flexible hose may include a high-temperature resistant fluororubber hose or the like.

In some embodiments, the flexible connection provided by the flexible hose accommodates angular adjustments of the photovoltaic panel while being pressure-resistant and corrosion-resistant, ensuring stable refrigerant circulation.

The peristaltic pump refers to a pump that propels fluid flow by compressing a flexible hose. For example, the peristaltic pump may include a roller-type peristaltic pump or the like.

In some embodiments, the power recovery assembly converts recovered energy (e.g., from photovoltaic power generation, mechanical energy, waste heat, etc.) into motive power for driving the peristaltic pump through mechanical or electrical means.

The refrigerant heat recovery heat exchanger refers to a heat exchange device that utilizes waste heat from the refrigerant at the outlet end of the condenser to preheat the returning refrigerant. For example, the refrigerant heat recovery heat exchanger may include a plate heat exchanger, a double-pipe heat exchanger, or the like.

In some embodiments, the refrigerant heat recovery heat exchanger recovers residual heat from the refrigerant at the outlet end of the condenser to preheat the liquid refrigerant entering the evaporator.

In some embodiments, the evaporator, installed on the backsheet of the photovoltaic panel, absorbs waste heat generated during operation of the photovoltaic panel, causing the refrigerant to evaporate and vaporize. The vaporized refrigerant is conveyed via the flexible hose to the condenser, where it releases heat during condensation. This released heat heats water in the water heating device to generate water vapor, which is then directionally sprayed onto the weed pile through the spraying nozzles to maintain a suitable temperature and humidity, thereby enhancing the trapping effectiveness for red imported fire ants. The refrigerant heat recovery heat exchanger further recovers waste heat from the condenser, improving the energy efficiency of the integrated system. Meanwhile, the peristaltic pump, driven by the power recovery assembly, propels the circulation of the refrigerant, forming a closed-loop heat exchange system.

In some embodiments of the present disclosure, the evaporator is closely attached to the back surface of the photovoltaic panel, rapidly absorbing and transferring waste heat, effectively reducing an operating temperature of the panel and significantly improving power generation efficiency. The heat released by the condenser is converted into water vapor via the water heating device and precisely delivered to the target area through the spraying nozzles, which not only enhances the trapping effectiveness but also achieves efficient utilization of thermal energy. The integrated system employs a closed-loop circulation design, where the refrigerant flow is driven by the peristaltic pump. The power recovery assembly converts mechanical energy from the photovoltaic panel into pumping power for the pump, reducing external energy consumption. The refrigerant heat recovery heat exchanger further recovers waste heat from condensation to preheat the returning refrigerant, forming a cascade utilization of thermal energy and substantially improving the overall thermal efficiency of the integrated system.

In some embodiments of the present disclosure, the filament cutting device, combined with laser sensing technology, can accurately identify a weed growth status and dynamically adjust a cutting frequency, avoiding the risk of collision with photovoltaic support structures inherent in traditional mechanical weeding. Simultaneously, the integrated pesticide spraying assembly enables simultaneous cutting and chemical application operations, significantly reducing manual maintenance costs. The conveying device, via its inclined structure and the power recovery assembly, automatically transports cut weeds to the low-elevation trapping device. The mechanical energy recovered by the power recovery assembly can drive the refrigerant circulation within the heat dissipation device, forming a closed-loop energy utilization system. The trapping device exploits the thermotactic behavior of red imported fire ants by utilizing heat released from the condensation end of the heat dissipation device to attract ant colonies. This is combined with precise chemical application by the spraying assembly to achieve a dual control effect of physical trapping and chemical extermination. The design of the evaporation end of the heat dissipation device being closely attached to the backsheet of the photovoltaic panel not only effectively lowers the operating temperature and boosts the power generation efficiency of the panel but also converts waste heat into auxiliary energy for pest control through heat exchange.

The working principle of the integrated system for weed removal and red imported fire ant control in a photovoltaic power plant provided by some embodiments of the present disclosure includes the following. As shown in FIGS. 2-3, by installing the filament cutting device below the photovoltaic panel and installing the laser sensor 7 on the filament cutting device, the growth status of weeds 1 is detected in real time. The filament cutting device is automatically activated at predetermined intervals to achieve automated clearance of the weeds 1, thereby reducing the cost of manual weed removal. The filament cutting device consists of the motor 2 and the elongate filament 3. When stopped, the elongate filament 3 remains stationary. During operation, upon activation of the motor 2, the elongate filament 3 rotates at high speed, generating sufficient shear force to cut the weeds 1. The electricity used by the motor 2 of the filament cutting device is supplied by the photovoltaic power plant. When photovoltaic power generation exceeds demand, the excess electrical energy is stored in a battery. If the battery is full, the remaining electrical energy is converted into thermal energy and delivered to a boiler for burning the weeds 1.

By arranging a collection trough below the filament cutting device and connecting the collection trough to the conveying device, which is equipped with the weight sensor 10, the conveying device is automatically activated for transport when a preset weight value is reached, thereby transporting the weeds 1 to the designated trapping device, and achieving an organic integration of the devices. By installing the stepper motor 12 and the pressure roller 13 on the conveying device, the kinetic energy generated by the movement of weeds 1 on the conveying device due to their own gravity is recovered. The recovered energy is stored in a battery or a capacitor of the stepper motor 12. The stepper motor 12 is then utilized to drive the peristaltic pump to circulate the refrigerant to the photovoltaic panel to cool the backsheet, thereby improving the efficiency of the photovoltaic panel.

By incorporating the pesticide nozzles 11 into the filament cutting device, an inhibitor can be sprayed through the nozzles 11 to slow down the growth of weeds 1 when their growth rate is excessively fast and exceeds the currently required usage. Conversely, when the boiler requires a large amount of weeds 1 for burning or a surge in red imported fire ant population leads to insufficient weed supply, a growth promoter can be sprayed through the pesticide nozzles 11 to stimulate weed growth. By employing the laser sensor 7 to monitor the growth status of the weeds 1, timely treatment of the weeds is enabled, preventing their erosion and damage to the photovoltaic panels. The trapping device aggregates red imported fire ants to encourage nesting, allowing for their comprehensive capture and preventing them from gnawing and damaging electrical wires of the photovoltaic power plant. Delphinium essential oil is applied to the drawstring mesh retaining cover 6 to prevent gnawing by red imported fire ants, thereby reducing the likelihood of their escape.

The refrigerant is conveyed via the flexible hose 14 to the evaporator 15 on the backsheet of the photovoltaic panel. The refrigerant undergoes heat exchange with the ambient air through the evaporator 15, vaporizing and absorbing heat in the process, thereby achieving a cooling effect that lowers the temperature of the backsheet and absorbs its waste heat. The vaporized refrigerant flows back to the condenser 4, where the absorbed heat is used to heat water, converting it into water vapor. The water vapor is then sprayed onto the weed pile 5 through the spraying nozzles 18 to preheat and dry the weed pile 5, thereby reducing an internal moisture content of the weed pile 5 while simultaneously increasing the temperature of the weed pile 5. This is beneficial as it facilitates normal combustion for heating when the weed pile 5 is subsequently fed into the boiler, and also enhances the attractiveness of the weed pile 5 to red imported fire ants, which prefer high temperatures.

The semi-cylindrical cover 16 is provided on the trapping device. The spraying nozzles 18 are arranged on the guardrail 17 installed along the semi-cylindrical cover 16. Due to the dispersed arrangement of the spraying nozzles 18, the sprayed water vapor has a low flow velocity, which does not disturb the red imported fire ants. Simultaneously, this arrangement helps create a high-temperature, high-humidity environment, prompting the red imported fire ants to congregate toward the trapping device for subsequent control. The semi-cylindrical cover 16 also serves to secure the drawstring mesh reataining cover 6 used by the trapping device.

By enclosing the weed pile 5 with the drawstring mesh reataining cover 6, after a period of time, when the red imported fire ants reach a certain population level or pose a potential threat, the weed pile 5 can be bundled by pulling the drawstring and then fed into the boiler for burning the weeds 1, thereby achieving the reuse of the weeds 1 and increasing a fuel source for the boiler. As the fuel source for the boiler is the weeds 1, its supply is inherently unstable, being influenced by factors such as weed growth patterns and weather conditions. Consequently, the heat supply from the boiler is also unstable. Therefore, the heat generated by the boiler is primarily used for supplying domestic hot water. On one hand, weeds 1 are easy to combust and require minimal energy to restart the boiler. On the other hand, when the supply of weeds 1 is insufficient and the demand for hot water is not high, the boiler can operate at a low load. Under such conditions, the heat generated from burning the weeds 1 is mainly used to maintain the boiler's own temperature rather than being supplied externally as hot water.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

It should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. An integrated system for weed removal and red imported fire ant control in a photovoltaic power plant, comprising:
a filament cutting device, installed below a photovoltaic panel, wherein the filament cutting device is configured to cut weeds below the photovoltaic panel; a laser sensor for detecting a weed growth status in real time is installed on the filament cutting device, and a pesticide spraying assembly is arranged on the filament cutting device;
a conveying device, wherein a collection trough is arranged at a bottom of the filament cutting device, and an end of the conveying device is connected to the collection trough; the conveying device is arranged in an inclined manner, and a power recovery assembly is arranged on the conveying device;
a trapping device, installed at another end of the conveying device, wherein an elevation of the trapping device is lower than an elevation of the collection trough; and a spraying assembly is installed on the trapping device; and
a heat dissipation device, wherein an evaporation end of the heat dissipation device is arranged on a backsheet of the photovoltaic panel, a condensation end of the heat dissipation device is arranged at a position corresponding to the trapping device, and the power recovery assembly is configured to drive a refrigerant in the heat dissipation device to flow.

2. The integrated system of claim 1, wherein the filament cutting device includes a motor, an elongate filament is connected to an output shaft of the motor; the laser sensor is installed on a top of the motor, a plurality of pesticide nozzles are arranged on a housing of the motor, and the plurality of pesticide nozzles are arranged circumferentially around the motor.

3. The integrated system of claim 1, wherein the conveying device includes a conveyor belt in communication with the collection trough, the conveyor belt is arranged in an inclined manner, a weight sensor is installed on the conveyor belt; and the power recovery assembly is operatively coupled to the conveyor belt.

4. The integrated system of claim 3, wherein a one-way baffle is installed on the conveyor belt.

5. The integrated system of claim 3, wherein the power recovery assembly includes a stepper motor, a pressure roller is connected to an output shaft of the stepper motor, and an end of the pressure roller is operatively coupled to a peristaltic pump in the heat dissipation device.

6. The integrated system of claim 1, wherein the trapping device includes a weed pile, and a drawstring mesh retaining cover is sleeved over an outer side of the weed pile.

7. The integrated system of claim 6, wherein a coating layer for preventing gnawing by red imported fire ants is provided on the drawstring mesh retaining cover.

8. The integrated system of claim 6, wherein the spraying assembly includes a fixing frame, a semi-cylindrical cover is installed on the fixing frame, and the semi-cylindrical cover is arranged above the weed pile; an iron guardrail is installed on an outer wall of the semi-cylindrical cover, the iron guardrail is arranged along a circumferential direction of the semi-cylindrical cover, a plurality of spraying nozzles are arranged on the iron guardrail, the plurality of spraying nozzles are used for spraying water vapor, and the plurality of spraying nozzles are arranged at equal intervals along a circumferential direction of the iron guardrail.

9. The integrated system of claim 8, wherein the heat dissipation device includes an evaporator and a condenser, the evaporator is installed on the backsheet of the photovoltaic panel, a water heating device is arranged at a position corresponding to the condenser, a water vapor outlet of the water heating device is in communication with the plurality of spraying nozzles; a loop is formed between the evaporator and the condenser through a flexible hose, a peristaltic pump is arranged on the flexible hose, and the power recovery assembly is operatively coupled to the peristaltic pump; an outlet end of the condenser is in communication with a refrigerant heat recovery heat exchanger, and an outlet end of the refrigerant heat recovery heat exchanger is in communication with the evaporator.
